(19) United States
(12) Patent Application Publication
(10) Pub. No.: US 2023/0401633 A1
(43) Pub. Date: Dec. 14, 2023

(54) METHOD AND SYSTEM FOR IMPROVED APPAREL FIT

(71) Applicant: Fitaba Holdings, Inc., New York, NY (US)

(72) Inventors: Robert Earl NIMON, Bullard, TX (US); David Alexander NIMON, Allen, TX (US)

(21) Appl. No.: 18/207,980

(22) Filed: Jun. 9, 2023

Related U.S. Application Data
(60) Provisional application No. 63/350,600, filed on Jun. 9, 2022.

(51) Int. Cl. G06Q 30/0601; G06T 7/60

(52) U.S. Cl. CPC G06Q 30/0643; G06T 7/60; G06Q 30/0621

(57) ABSTRACT

A system and method to determine a correct garment fit, where a fit is represented as a label which includes shape and size, and is suitable for mapping to garments manufactured appropriate to that representation. The system provides a user interface including a perception interface enabling user fit perception choices, and measurement interface for capturing measurement data, a measurement analysis server and a fit analysis server. The measurement server receives data from the user interface to produce a measurement representation. The fit server receives data from the user interface to produce a fit representation. The method includes receiving, from a client, a garment fit query which includes a garment type, the client's perception of garment fit, and a set of client body measurements; calculating a prediction of the client's perception fit; and calculating a predicted final fit based on the client's perception fit and the client body measurements.

### CROSS REFERENCE TO RELATED APPLICATION

This patent application claims the benefit of U.S. Provisional Application, Ser. No. 63/350,600, filed Jun. 9, 2022, the content of which is incorporated by reference herein in its entirety.

### FIELD OF INVENTION

The present invention relates to the field of apparel fitting and distribution and, in particular, to a system and method to improve the fitting for and reduce the return rate of garments purchased by consumers.

### BACKGROUND OF RELATED ART

Providing proper fit of garments to consumers has always been difficult, as evidenced by the high return rates of various types of apparel in the online fashion market for apparel fit. The high return rates in the garment industry can have significant costs such as administrative, sales, restocking, shipping costs among other well-known economic costs and societal impacts.

An article available at the website from the Atlantic shows that for fashion products, the return rate can well exceed 30%. (See https://www.theatlantic.com/magazine/archive/2021/11/free-returns-online-shopping/620169/).

A key component to causing fashion return rates that high relates to brands being forced to encourage bracketing, where a customer orders multiple sizes and subsequently returns the garments that do not fit properly.

There are two main factors that apply to this issue of providing a consumer with that “perfect fit” and the associated satisfaction:
The product must be able to fit the person.
The sales process must be able to match the person to the product most likely to fit specifically to the person.

Part of the problem in the fashion/garment industry has been that the apparel product design process has notable issues in both of these areas. The general approach to apparel designing leaves a lot of the populace out of the equation, focusing too much and being inflexible on certain size profiles. An important goal is to create a garment fit with a design process that accounts for the shape of a person's body.

It is noted that direct involvement with fit specialist can provide the consumer with a better fit and therefore help reduce the return rate. Studying that process, it can be observed that this change in return rate is primarily due to additional questions that get asked coupled with the experience (domain expertise) of the personalized fit specialist to interpret the responses. However, using a fit specialist as part of the process can have adverse effects on the sales process:
Asking too many questions results in too much friction in the call to action for purchase resulting in less sales conversion
Any change in the process that does not engender confidence in the process could tend to introduce more bracketing, resulting in more returns rather than fewer.

Therefore, there is a need for a system and method to improve the fitting for and reduce the return rate of garments purchased by consumers.

### SUMMARY

A system and method implemented by a computer to determine the correct garment fit, where a fit is represented as a label which includes shape and size, and is suitable for mapping to garments manufactured appropriate to that representation. The system provides a user interface including a perception interface (presents and enables selection of user fit perception choices) and measurement interface (presents and enables options for capturing measurement data), measurement analysis server, fit analysis server. The measurement analysis server receives from the user interface running concurrently data communicated and analyzes the data to produce a measurement representation. The fit analysis server receives from the user interface running concurrently data communicated and analyzes the data to produce a fit representation. The method provided includes the steps of: (i) acquire perception representation, (ii) acquire measurement representation related to specific body Points of Measurement, and (iii) calculate fit representation using perception and measurement representations.

In one embodiment, a method for providing a garment fit to a consumer by a garment fit system providing access to the consumer over an electronic network includes: providing an electronic user interface to a consumer client, the electronic user interface including access to a fit perception quiz and body measurement capture workflow; receiving a garment fit query from the client, the query comprising a garment type, the client's perception of garment fit, and a set of client body measurements; calculating a prediction of the client's perception fit; and calculating a prediction of the client's final fit based on the client's perception fit and the client body measurements.

In one aspect, the body measurement capture workflow consists of capturing client body images using a camera and analyzing said images to determine certain body measurements. In another aspect, the certain body measurements are specific Points of Measurement as determined using the garment type. In another aspect, the perception fit calculation is based on one or more table lookups using responses from the perception fit quiz as keys with the perception fit represented as a fit label formed using garment size and shape. In a further aspect, the final fit calculation comprises a combination of table lookups using responses from the perception fit quiz along with the body measurements and the final fit represented as a fit label formed using garment size and shape.

In another embodiment, a system provides a garment fit to a consumer by a garment fit system providing access to the consumer over an electronic network, in which the system includes a non-transitory computer-readable medium with instructions encoded thereon and one of more processors configured to, when executing the instructions, perform operations of: providing, via an electronic user interface, a fit perception quiz and body measurement capture workflow for a garment selected by a client; coding garment fit query responses received from the client, the coded query responses being associated with a garment type, client perception of garment fit, and a set of client body measurements; determining a predicted perception fit of a garment for the client based on data associated with the coded garment type and client perception of garment fit; and determining a predicted final fit based on the predicted perception fit and the body measurements.

In still another embodiment, a method for providing a garment fit to a consumer by a garment fit system providing access to the consumer over an electronic network is provided in which the method comprises: receiving, at a fit analysis subsystem of the garment fit system, perception metadata representative of a perceived fit of a garment selected by the consumer, said perception metadata including a metric that characterizes perceived size and shape associated with a fitting of the selected garment on the consumer, said first metadata being inputted into the measurement analysis subsystem by the consumer via a user interface; receiving, at a measurement analysis subsystem of the garment fit system, measurement metadata including measured dimensions of the consumer located at predetermined points of measurement associated with the selected garment; determining, by the fit analysis subsystem, a predicted perception fit label for the selected garment, said predicted perception fit label including at least size and shape values corresponding to the perception metadata from the consumer; and comparing, via the fit analysis subsystem, the predicted perception fit label to the received measured dimensions of the consumer; and adjusting the predicted perception fit label based on the measured dimensions of the consumer to provide a final fit label that includes at least final size and shape values of the selected garment.

In one aspect, the method further includes displaying, on a user interface connected to the electronic network, at least one image of the selected garment associated with the final fit label; and presenting purchasing information to enable the consumer to buy the selected garment over the electronic network.

In another aspect, the purchasing information includes values associated with at least one of style variations, quantity and price. In yet another aspect, the style variations include at least one of a choice of patterns, colors, fasteners and fabrics.

### BRIEF DESCRIPTION OF THE DRAWINGS

FIG. 1 is a block diagram of a garment fit system in accordance with an embodiment of the invention.

FIG. 2 is a block diagram illustrating the different modules inside the measurement analysis subsystem, in accordance with an embodiment of the invention.

FIG. 3 is a block diagram illustrating the different modules inside the fit analysis subsystem, in accordance with an embodiment of the invention.

FIG. 4 is a flowchart of an exemplary method of the fit analysis subsystem for producing a final fit label, in accordance with an embodiment of the invention.

FIG. 5 is a flowchart of an exemplary method of the fit analysis subsystem for generating garment metadata, in accordance with an embodiment of the invention.

FIG. 6 is a flowchart of an exemplary method of the fit analysis subsystem to acquire the user's perception of fit, in accordance with an embodiment of the invention.

FIG. 7 is a flowchart of an exemplary method of the fit analysis subsystem to acquire the user's measurements, in accordance with an embodiment of the invention.

FIG. 8 illustrates example fit perception sizing tables in accordance with an embodiment of the invention.

FIG. 9 is a flowchart of an exemplary method of the fit analysis subsystem that produces a perception fit label, in accordance with an embodiment of the invention.

FIGS. 10A, 10B, and 10C illustrate final fit sizing tables, in accordance with an embodiment of the invention.

FIGS. 11A, 111B, and 11C collectively form a flowchart of an exemplary method of the fit analysis subsystem that produces a final fit label, in accordance with an embodiment of the invention.

FIGS. 12A and 12B collectively form a flowchart of an exemplary method of the fit analysis subsystem that checks for the effect of incrementing the predict fit prediction size, in accordance with an embodiment of the invention.

FIGS. 13A and 13B collectively form a flowchart of an exemplary method of the fit analysis subsystem that finds the best fit choice between two shapes, in accordance with an embodiment of the invention.

FIGS. 14A, 14B, 14C, 14D, 14E, 14F, 14G, and 14H collectively form a flowchart of an exemplary method of the fit analysis subsystem that checks a best fit prediction against a set of domain specific conformance rules, in accordance with an embodiment of the invention.

FIG. 15 is a flowchart of an exemplary method of the fit analysis subsystem that calculates a size using the hip sizing table, in accordance with an embodiment of the invention.

The figures depict an embodiment of the present invention for the purposes of illustration only. One skilled in the art will readily recognize from the following discussion that alternative embodiments of structures and methods illustrated herein may be employed without departing from the principles of the invention described.

The figures use like reference numerals to identify like elements. A letter after a reference numeral, such as “102A” indicates that the text refers specifically to the element having the particular reference numeral. A reference numeral in the text without a following letter, such as “101”, refers to any or all of the elements in the figures bearing that reference numeral (i.e., “101” in the text refers to “101” and “101A”).

### DETAILED DESCRIPTION

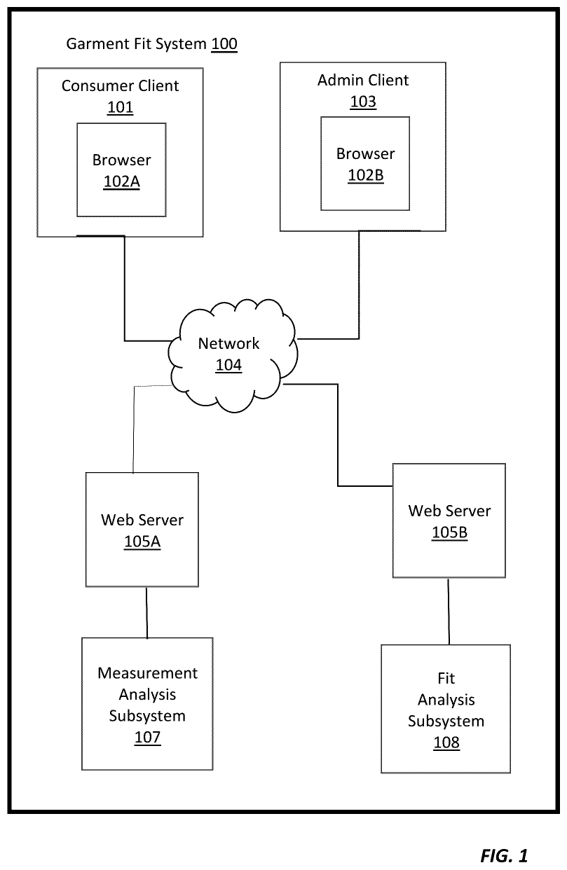

Referring to FIG. 1, there is shown a block diagram of a system architecture adapted to support one embodiment of a garment fit system 100. The network represents communication pathways between a consumer client 101, an administrative client 103, and web servers 105A and 105B. In one embodiment, the communication network 104 is the Internet. The network 104 can also utilize dedicated or private communication links (e.g., WAN, LAN, MAN) that are not necessarily part of the internet. The network can be implemented with standardized and well-known commercially available communication technologies and/or protocols.

The web servers 105A and 105B present web pages or other web content, which form the basic interface to the consumer and admin clients 101, 103. Consumers and system administrators use respective client devices 101, 103, e.g., having web browsing capabilities and user interfaces (e.g., keyboard, mouse, touchpad) to access one or more web pages and provide data to the measurement analysis and fit analysis subsystems. In the context of this invention, “data” is understood to include information about the consumer's perception of his or her garment fit. For example, the information may contain the consumer's perception of what size is normally bought in other garment products in addition to how well that size fits normally. The information may also include preferences for how a garment should fit (e.g., “tight” or “loose”).

In one preferred embodiment, the client devices 101, 103 and web servers 105A, 105B can be any device that is or incorporates a computer such as a desktop computer, a laptop computer, a notebook, a smartphone, a traditional server architecture, or the like. A computer is a device having one or more general and/or special purpose processors, memory, storage, and networking components (either wired or wireless). The device executes an operating system, for example, a Microsoft Windows—compatible operating system (OS), Apple OS X or iOS, a Linux distribution, or Google's Android OS. In some embodiments, the client device 101, 103 may use a web browser 102A, 102B, such as Microsoft Internet Explorer, Mozilla Firefox, Google Chrome, Apple Safari and/or Opera, as an interface to interact with the web servers 105A, 105B and consequently to interact with measurement and fitness analysis subsystems 107, 108. These two analysis subsystems 107, 108 comprise additional components and modules as described below.

Measurement Analysis Subsystem

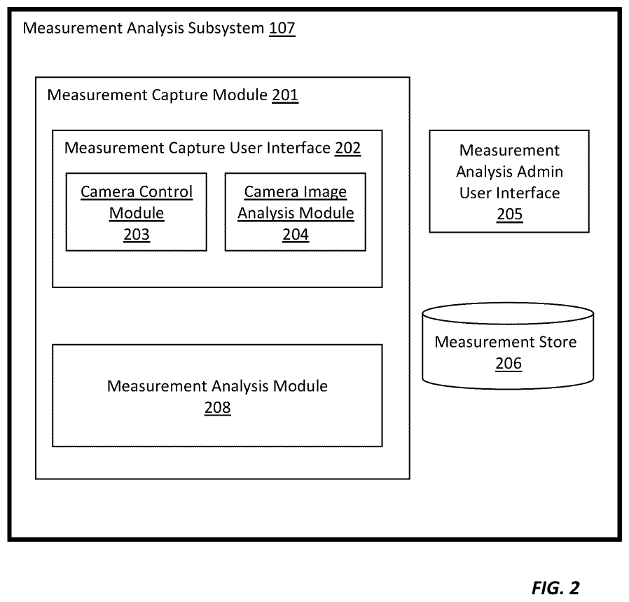

Referring to FIG. 2, in one embodiment the measurement analysis subsystem 107 includes a measurement capture module 201, a measurement analysis admin interface 205, and a measurement store 206. The capture module 201 for this embodiment is further comprised of a measurement capture user interface 202, containing a camera control module 203 and a camera image analysis module 204, and a measurement analysis module 208.

In this illustrative embodiment, the measurement capture module user interface 202 presents a web page containing instructions and well-known web page controls to help the consumer obtain/capture photo images from the client device camera. In a preferred embodiment, the capture module user interface 202 instructs the consumer how to pose for the photos, detects when the pose is correct, and uses the device camera to capture the consumer's photo images. The images are processed in the measurement analysis module 208 to produce a set of measurements called herein “Points of Measurement”.

The Points of Measurement are tagged with consumer identification and saved in the measurement store 206. The measurement analysis admin user interface 205 presents one or more web pages to display the consumer and Points Of Measurement data retrieved from the measurement store 206.

In a preferred embodiment, the measurement analysis subsystem 107 is a service provided by companies in the measurement market service market such as Mirror Size or 3DLOOK. A person of ordinary skill in the art will recognize that other commercially available products can be used, as well as other software products and tools that may be used to custom build the same.

Fit Analysis Subsystem

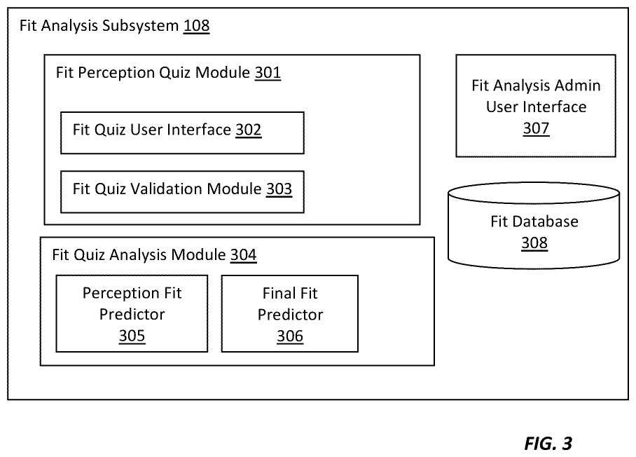

Referring to FIG. 3, in one embodiment the fit analysis subsystem 108 includes a fit perception quiz module 301, a fit quiz analysis module 304, a fit analysis admin user interface 307, and a fit database 308. The fit quiz perception module 301 includes a fit quiz user interface 302 and a fit quiz validation module 303. The fit quiz analysis module 304 comprises a perception fit predictor 305 and final fit predictor 306.

In a preferred embodiment, a consumer on the client device is presented with a web page by the fit quiz user interface 302, which displays quiz soliciting response choices to questions eliciting the consumer's perception of his/her garment fit, which are then checked with the fit quiz validation module 303 for errors and omissions. The resulting perception data is coded and analyzed by the fit quiz analysis module 304, and more specifically, by the perception fit predictor 305 and final fit predictor 306.

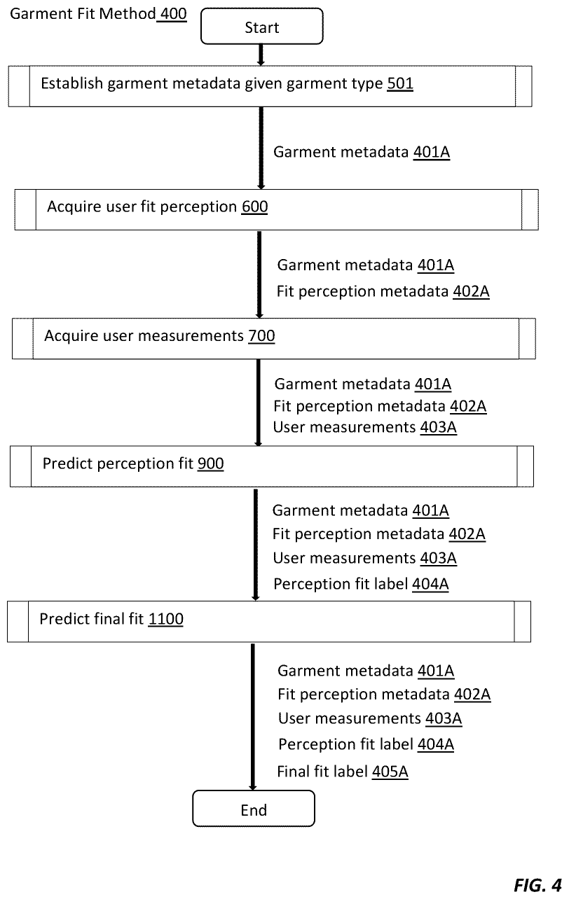

Referring to FIG. 4, a preferred embodiment of a novel method for improving garment fit for a consumer (e.g., for purchase over the Internet) is illustratively shown. The method 400 comprises a series of routines each including various steps which establish garment metadata for a specific garment type 501 (e.g., pants, dress, etc.), acquire user fit perception 600, acquire user measurements 700, predict perception fit 900 and, lastly, predict a final fit 1100 which is based on the previously obtained predicted perception fit and user measurements.

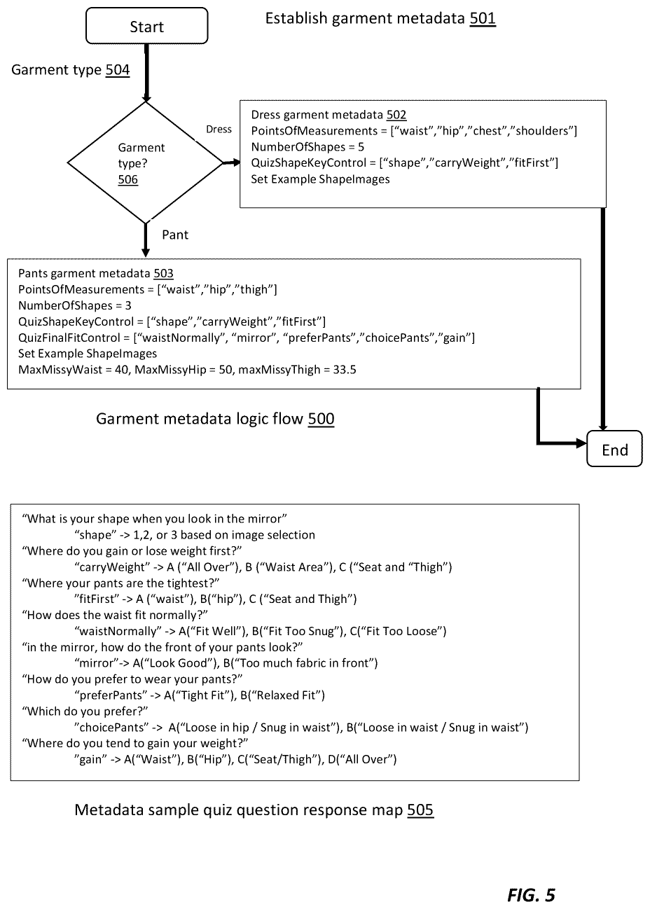

Referring to FIG. 5, the garment metadata function 501 in this exemplary flowchart accepts a garment type requested at 506 (example shown support “pants” and “dress” garment types), but additional embodiments for other garment types are supported which can be manufactured using shape as integral to the garment design (i.e., “tops”, “swimwear”, “loungewear”, “underwear”, etc.) and integral to its fit labeling. The example garment metadata for pants 503 provides critical control data including the number of shapes supported (3, in this example), the Points of Measurement (waist, hip and thigh, in this example), a set of data used to support the perception quiz, including a set of example shape images, size ranges, etc.

The primary output of the function 501 is metadata (401A), which is used by the other routines in method 400 to control calculations to obtain an improved garment fit.

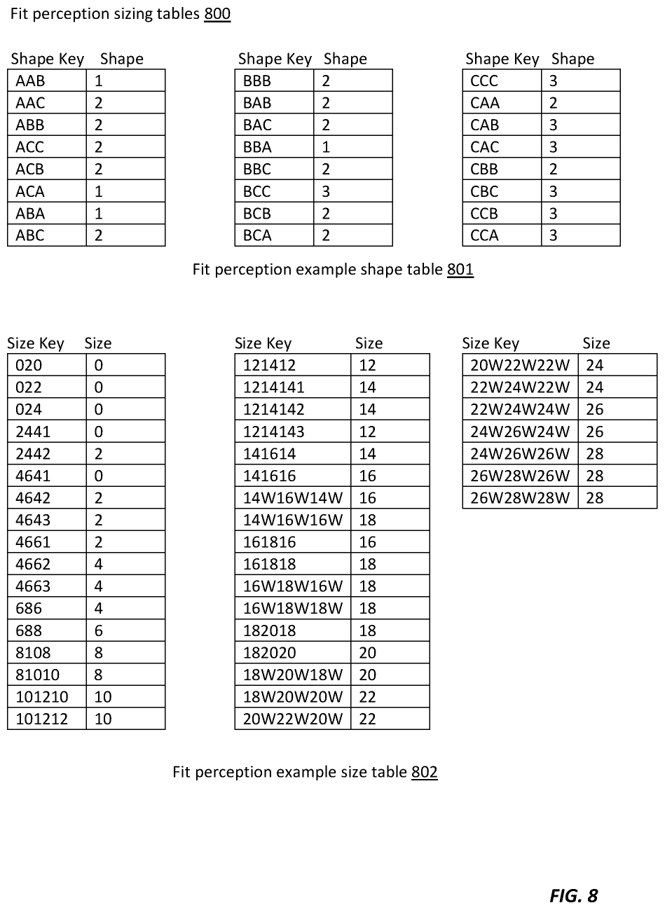

Referring to FIG. 4, at step 600 of the garment fit method 400, the user's own perception of fit is obtained. The overall purpose of the garment fit method 400 is to predict the user's final fit, with an important aspect of that prediction being controlled by the user's own perception of fit, as illustratively represented by fit perception metadata 402A, which is generated by function 600. The fit perception metadata 402A (for all supported garment types, such as pants, dresses, swimwear, among other garment types) is generated via a quiz (or survey) presented to the user via the fit quiz user interface 302 with responses processed by the fit quiz validation module 303. The fit quiz is a set of questions which are displayed on a user interface (e.g., monitor/screen) of the consumer and are designed to elicit information about the user's current perception of garment fit across any/all products that have been purchased in the past. The consumer's responses to the quiz questions are processed using quiz question response map (505). The purpose of the response map 505 is to validate the user response and convert the response into a normalized structure suitable to indexing into tables, as discussed below with reference to FIG. 8. Referring to FIG. 5, the response map 505 is an example of a partial map for use with women's “pants” type of a garment.

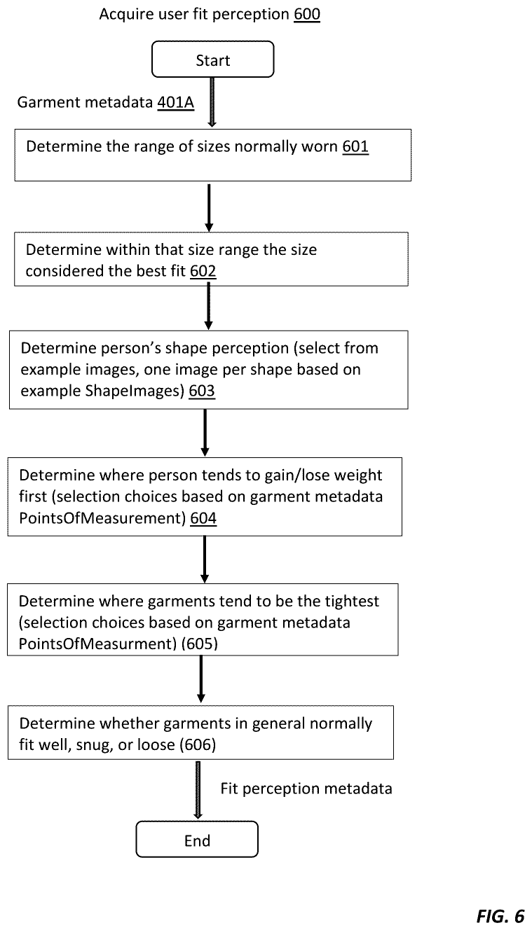

Referring to FIG. 6, fit perception metadata is acquired from the user. Continuing with the “pants” garment example, the questions and response map support representing the user's perception of his/her “normal” size range (601), the size within that range with the highest likelihood of being considered as the best fit (602), the user's own perception of his/her shape using example images as a guide (603), the user's perception of where in the garment shape Points of Measurement he/she tends to gain/lose weight first (604), which of the Points of Measurement tend to fit the tightest (605), and whether in his/her perception the garments in general tend to fit well, snug, or loose (606).

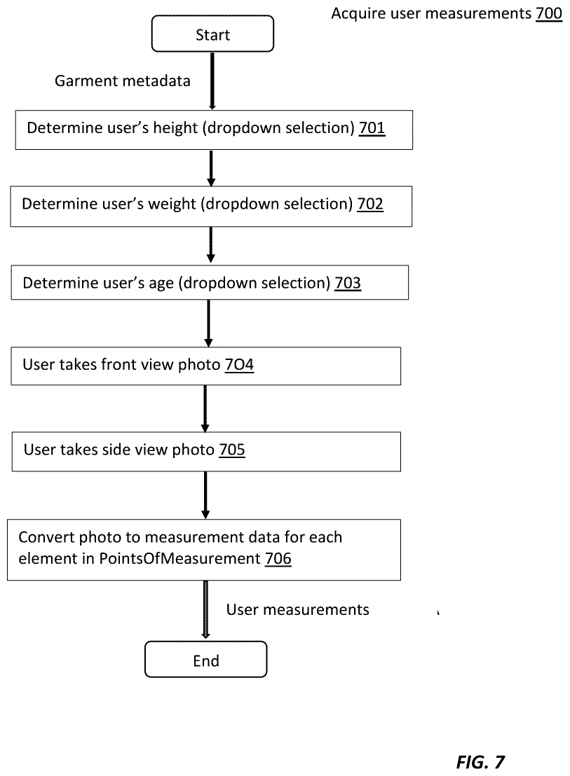

Referring again to FIG. 4, while guiding the user by the perception quiz/query questions and gathering the corresponding data related to fit perception towards a final fit, a next step is to acquire the user's measurements for the Points of Measurements specified in the garment metadata (501) via a method for acquiring user measurements 700, as illustratively shown in FIG. 7. A person of ordinary skill skilled in the art will appreciate that there are numerous techniques to acquire body measurements given a list of Points of Measurement. In a preferred embodiment, the method 400 includes using a digital camera that is part of a smart phone to take photos of the user's body and to use image analysis techniques to extract measurements for the specified Points of Measurement. Other embodiments are supported, including requesting the user, as part of the perception quiz, to take his/her measurements with a tape measure. Additional embodiments may use a video taken of the user for analysis rather than photos.

In a preferred embodiment, two photos are acquired (a front view 704 and a side view 705). The photos of the consumer are analyzed in step 706 along with a set of information to guide the analysis such as the user's height 701, weight 702, and age 703. The analysis results in user measurements 403A, with one embodiment for “pants” consisting of measurements for “waist”, “hip”, and “thigh”.

Referring again to FIG. 4, a next step in the garment fit method 400 includes routine 900, which predicts the user's perception fit 900 resulting in the perception fit label 404A. In this embodiment, the predicted fit labels are represented as strings of characters, preferably in a form of “x.y”, where “x” represents the user's fit size and “y” represents the user's fit shape. Thus, by way of example, a fit label of “1.2” represents a user with a garment fit size of “1” and a fit shape of “2”. The garment fit method 400 initially generates a perception fit label 404A and subsequently a final fit label 405A. The perception fit label is intended to be the consumer's fit that is based solely on his/her perception, as discussed above, where the consumer's perception is based on the quiz responses. The final fit label is generated using the perception fit size (label) coupled with analysis of the user's measurement data 403A. The final fit label 405A is preferably in the same form as the perception fit label 404A.

The invention described herein is structured to take advantage of the fact that the perception fit is generally correct (based on several years of historical data for one of the embodiments) approximately 85% of the time. The objective of the garment fit method 400 is to use an analysis of the consumer's measurements to improve that percentage, observing that prior art methods of using similar measurements directly fails to achieve the 85% benchmark.

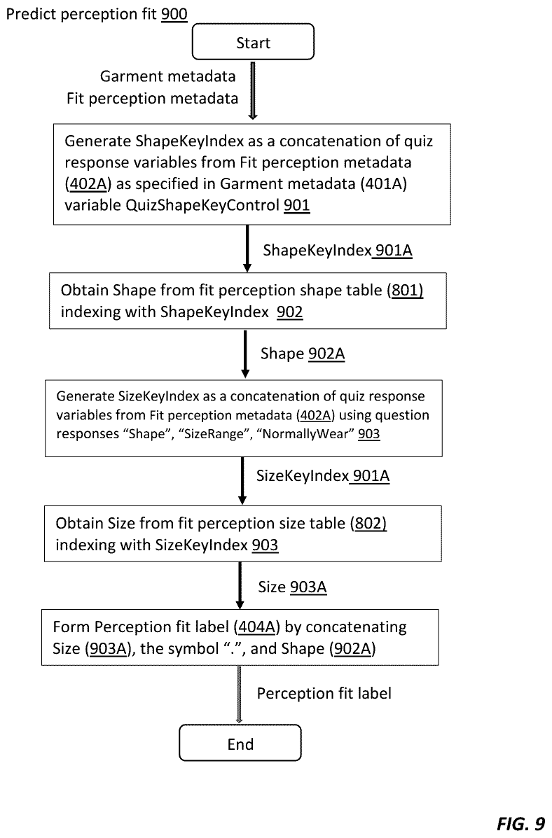

The initial fit prediction is based on user perception and is generated by routine 900, as illustratively shown in FIG. 9. An important goal of routine 900 is to determine a size and a shape and use those to form the perception fit label 404A in the form described above.

Referring now to FIG. 8 two example tables used to aid the algorithm in routine 900 are illustratively shown. Specifically, an example shape table 801 and an example size table 802 are provided. The two tables are formed such that they can be indexed with data from the perception quiz in which the answers/responses to the perception quiz are coded, e.g., as alphanumeric values, although such coding format is not considered limiting. The shape table 801 is indexed with a variable 901A called a “ShapeKeyIndex”, which is illustratively formed as a string concatenation of three quiz response variables, although such number of quiz response variables is not considered limiting. A person of ordinary skill in the art will appreciate that string concatenation is the act of taking individual character strings (each of which is comprised of one or more characters) and joining them into one larger character string. In the present example for a ShapeKeyIndex, this involves concatenating the quiz responses as specified in the example QuizShapeKeyControl (i.e., garment metadata example 503). Referring to the response map example 505 along with the QuizShapeKetControl example 503 of FIG. 5, the illustrative algorithm requires three QuizShapeKeyControl variables: (i) “shape”, (ii) “carryWeight”, and (iii) “fitFirst”. The shape variable using the response map can be assigned a character, e.g., of either an “A”, “B”, or “C”, corresponding to example shapes 1, 2, or 3 respectively. It is noted that the example shapes are pictorial or photo images that are presented to and selected by the consumer during the perception quiz. The second “carryWeight” variable from the response map can be either an “A” (representing “All Over”) or a “B” representing “Waist Area” or “C” representing “Seat and Thigh”. The third fitFirst variable from the response map can be either “A” for “Waist, “B” for “Hip”, or “C” for “Seat and Thigh”.

Referring to the illustrative shape table 801, if a user responded with a shape A, a carryWeight of B (indicating he/she tends to gain weight in the waist area), and a fitFirst of B (indicating he/she tends to fit tightest in the hip), then the ShapeKeyIndex formed from the concatenation of these response strings in this example is “ABB” and, therefore, the resulting shape obtained from table 801 during step 902 is shape “2” 902A.

Similarly, the example size table 802 is indexed with the concatenation of response quiz data related to the size range and preferred size within that range that the user normally wears, with some table entries also requiring the shape 902A. In one embodiment, the size table is constructed for compactness recognizing that most of the queries into the table can be resolved with only the combination of the user's perception of size range and his/her normally worn size within that range. For these queries, for example, if the user normally wears a fit within the range of 0-2 and normally wears a 2, then query will result in a size “0” and doesn't use the shape variable 902A. In that case, the SizeKeyIndex formed would be “022”, yielding a “0” size as shown in the example table 802.

On the other hand, if the size range is 4-6 in this example, then the calculation of the SizeKeyIndex requires the range, the size normally worn, plus the shape key 902A. So, if the user indicates that he/she wears a 4-6, with a 6 being the normal size and then the perception shape 902A is a 2, the ShapeKeyIndex formed (for this example) is “4662”, resulting in a size 4 from the table 802 query, with a resulting prediction fit label of “4.2” (size 4, shape 2). If the user's shape had been a “1” instead of a “2”, then the ShapeKeyIndex would be “4661”, resulting in a query result in that case of a size 2, with a resulting prediction fit label of “2.1” (size 2, shape 1).

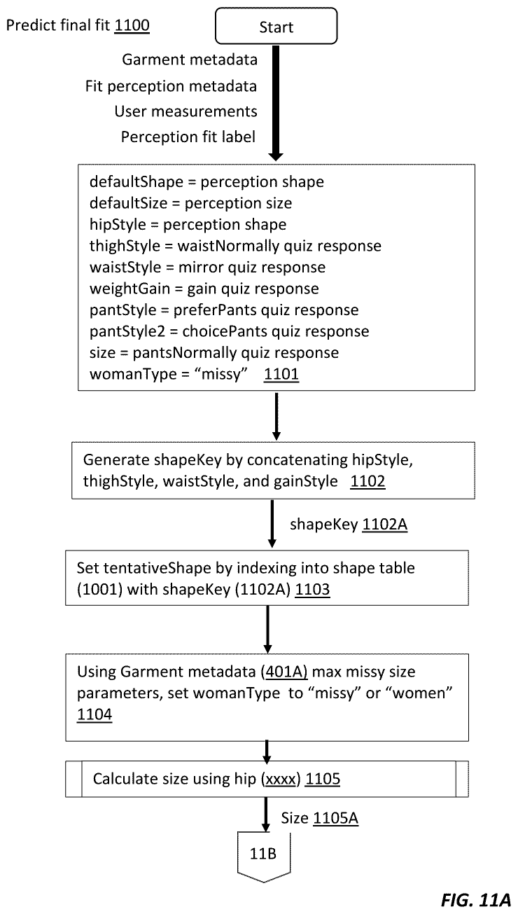

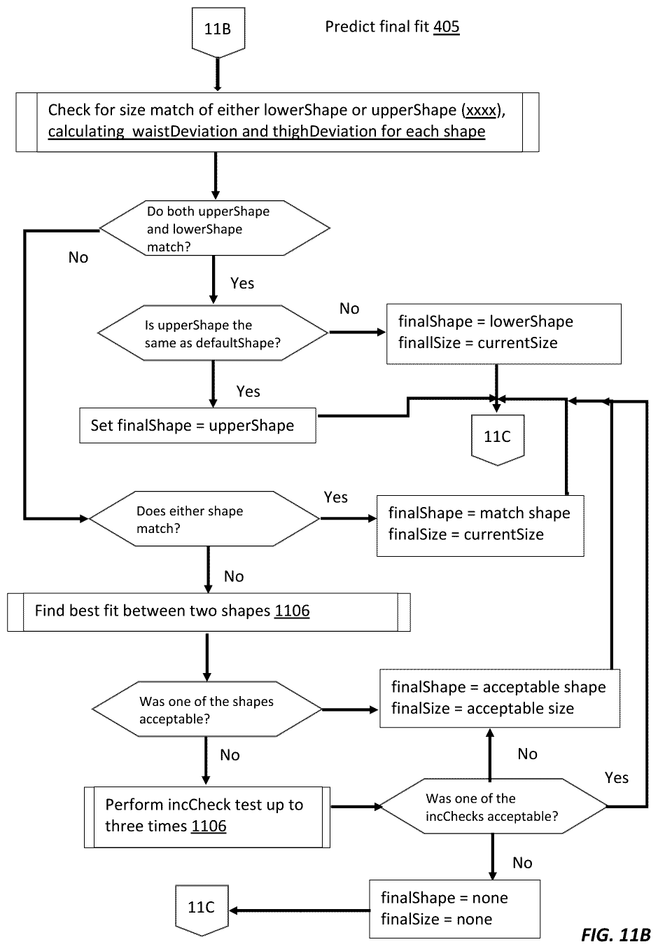

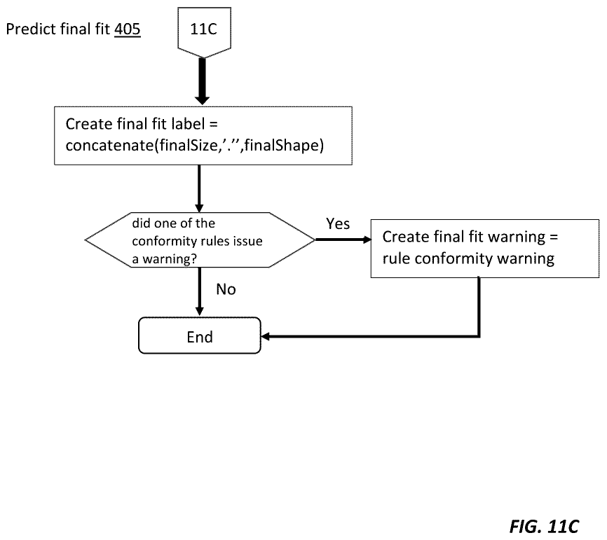

At this stage, the garment fit method 400 has generated a predicted perception fit 900 resulting in a perception fit label 404A as described above. Referring to FIG. 4, a next step in the garment fit method predicts the user's final fit 1100 and associated final fit label 405A. An example embodiment for predicting the final fit (given the combination of the garment metadata, fit perception metadata, user measurements and perception fit label) is depicted in the flowcharts in FIGS. 11A, 11B, 11C, 12A, 12B, 13A, 13B, 14A, 14B, 14C, 14D, 14E, 14F, 14G, 14H, and 15.

As shown in FIG. 11A, the predicted final fit method 1100 starts with establishing a set of initial variables in step 1101. These figures and steps depict an example embodiment for predicting the final fit for a garment type of “pants” produced for females that are classified as either “women” or “missy” sizes, where these initial variables are established using a combination of perception fit, quiz response and garment metadata. The main focus of the algorithm in the pants garment example is to establish an initial value of the final fit based on the perception fit and then improve on the accuracy of that value using primarily the user measurements 403A as a “cross check”. In other words, the final fit prediction is based on determining if the user's perception fit “makes sense” given the reality of her actual measurements or if there is a better (more accurate) final fit that can be determined with this extra data as input. A person of ordinary skill in the art will appreciate that different sets of tables would be used to obtain different classifications for female sizes, male sizes associated with different garment types such as dresses, tops, swimwear, and the like. The main commonality for any type of garment being fitted in the present invention is the requirement for the garment sizes to use shape as an integral component. What is disclosed is a novel method of mapping the provided information (user quiz responses and user measurements) to accurately predict a garment fit, where the fit is represented by a fit label that contains both a size and shape.

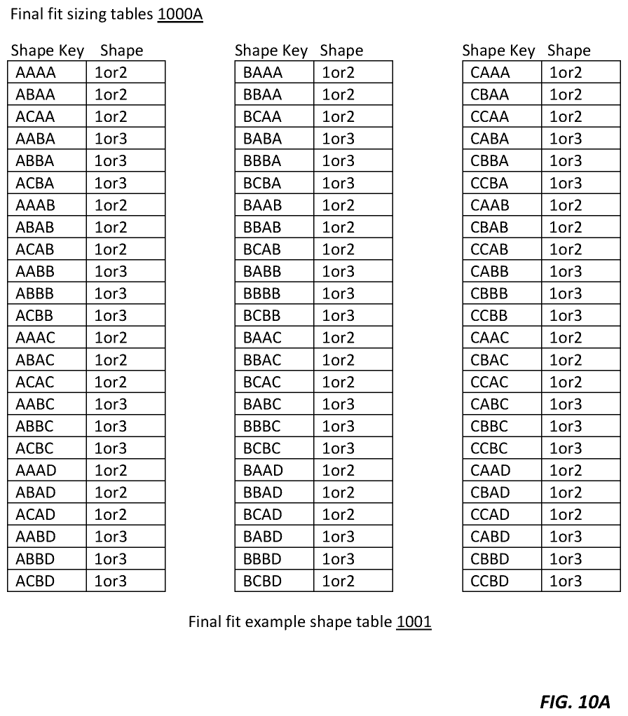

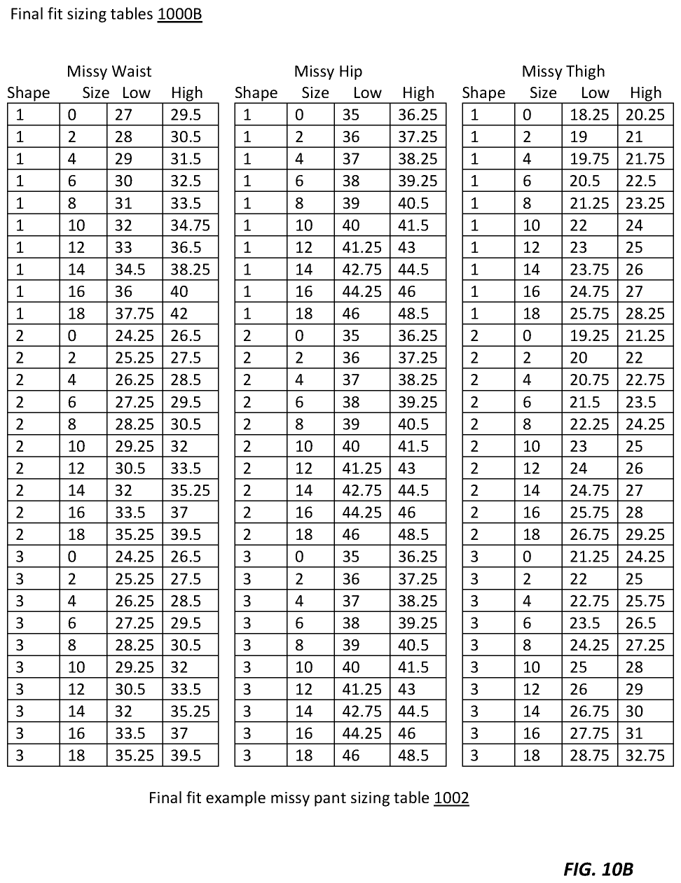

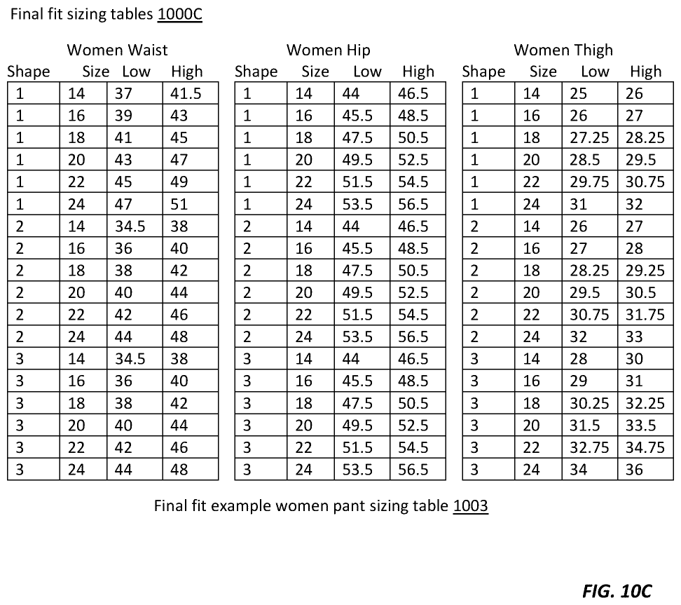

To perform the cross check, the algorithm of routine 1100 first sets a tentative shape at step 1103, which uses a shape table as exemplified in FIG. 10A (final fit sizing table 1000A). The shape table is organized to be indexed by a shapeKey (calculated in step 1102) as a concatenation of the designation characters for the hip style variable (which is the perception fit shape as discussed above), the thigh style character which is the quiz response map output for the waistNormally size (the size the user normally wears within her size range), the waistStyle which is her perception quiz response to how she looks in the mirror normally, and the gainStyle which is her perception quiz response to where she tends to gain weight (represented as one of the Points of Measurement associated with the garment product metadata).

As can be seen in the example shape table 1001, this shapeKey query into the table results in a shape representation similar to “1or2” or “1or3”. The implication of this representation is that at this stage in the method flow, the algorithm has tentatively decided that the final fit shape will be either a 1 or 2 (for “1or2”) as an example. As the algorithm progresses, the focus is to determine which of those alternatives is the best fit. A person of ordinary skill in the art will understand that shapeKey may have different shape results in the tables for other types of garments selected by the consumer.

As a basis for this determination of best fit, sizing tables as exemplified in FIG. 10B (sizing table 1002 for “missy” classification) and FIG. 10C (sizing table 1003 for “women” classification) are generated that are used that are based on the garment patterns used for production of the product. Recalling that the example pants garment metadata (503) provided maximum missy waist, hip, and thigh measurements if the user's associated Points of Measurement values for the waist, hip, and thigh are numerically less than those specified maximums, this best fit cross check algorithm assumes the initial best fit classification for the user is missy and otherwise assumes the classification women. Based on that classification, either the sizing table 1002 or 1003 is scanned to determine an initial size based on the hip measurement. As can be seen in the example missy size table 1002, each garment size for each garment shape is represented with a size range (low to high). For example, shape 1 size 2 for the hip measurement is represented as a range with a low value of 36 (inches) and a high value of 37.25 (inches).

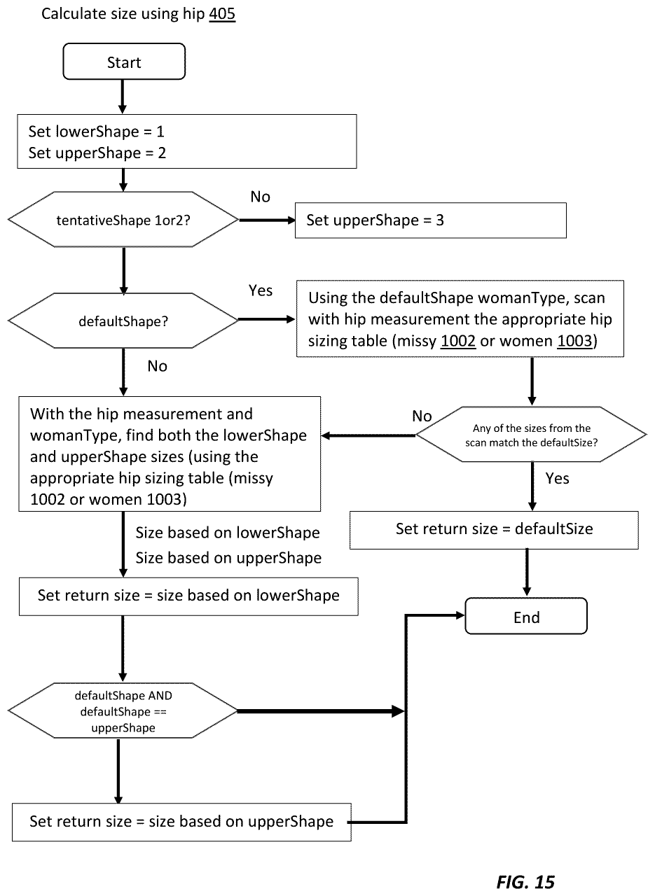

This best fit cross check then starts with two tentative shapes (i.e., 1 or 2) and then uses the hip measurement to determine a tentative size within each of those shapes. When the algorithm scans the table to determine which range a measurement falls within, it takes the first one that matches. So, as an example, if the tentative shapes are 1 and 2 and the user hip measurement is 37 inches, the size for shape 1 that is selected by the scan would be a 2 and the size for shape 2 would also be a 2. Looking at FIG. 10B, the first instance where a 37-inch hip measurement falls occurs, i.e., falls within a range of 37.0-37.99 for shape 1 is located on the second line of the table 1002 from which the low is 36 inches and the high is 37.25 inches. Thus, the corresponding size is a 2. Similarly, the first instance where a 37-inch hip measurement appears in the Table 1002 (i.e., within the range of 37.0-37.99) for shape 2 is on the twelfth line in which the low and high values are again 36 and 37.25, respectively. Thus, the corresponding size is also a 2. It is noted that the algorithm and table structure support the determination to select a different size for each shape. A flow diagram of the part of the routine used to calculate this initial size using the hip measurement is illustratively shown in FIG. 15.

The method then must determine which of these tentative shape/size combinations is a better fit. That determination is performed primarily by comparing additional points of measurements, e.g., looking at how the waist and thigh measurements (continuing the pants garment type example) indicate fit. The algorithm calculates a waistDeviation and thighDeviation for each of the tentative shape/size combinations (referring to FIG. 11B). In the example being discussed (tentative shapes 1 and 2), there is used the concept of the lowerShape (in this case 1) and the upperShape (in this case 2). There are also a defaultShape and defaultSize variables defined. The defaultShape is initially the same as the user's perception shape. The defaultSize is the perception size. This distinction supports giving priority for cases where both shapes fit. In the example flow, the lowerShape is preferred if both shapes are deemed to fit.

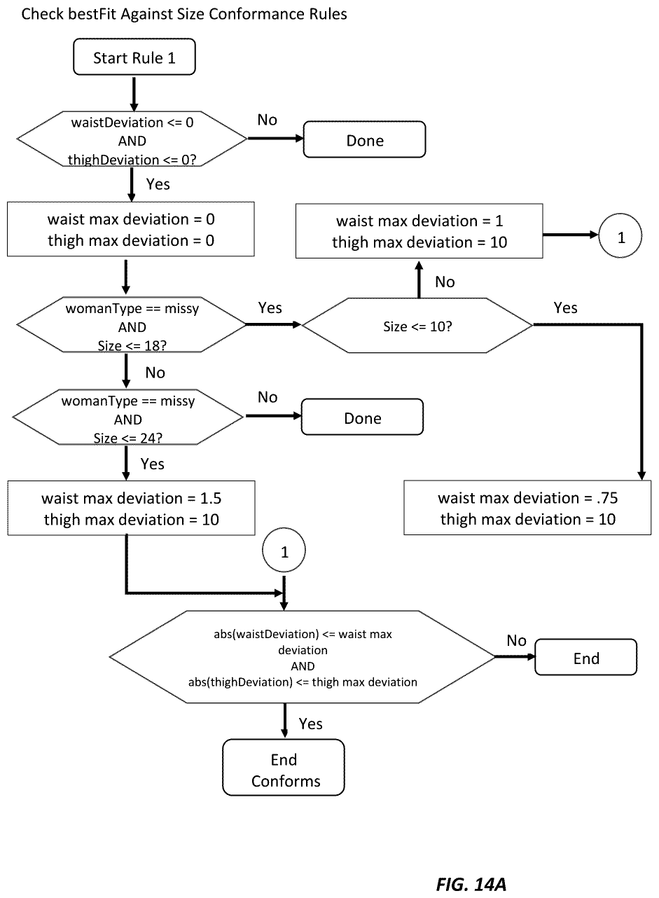

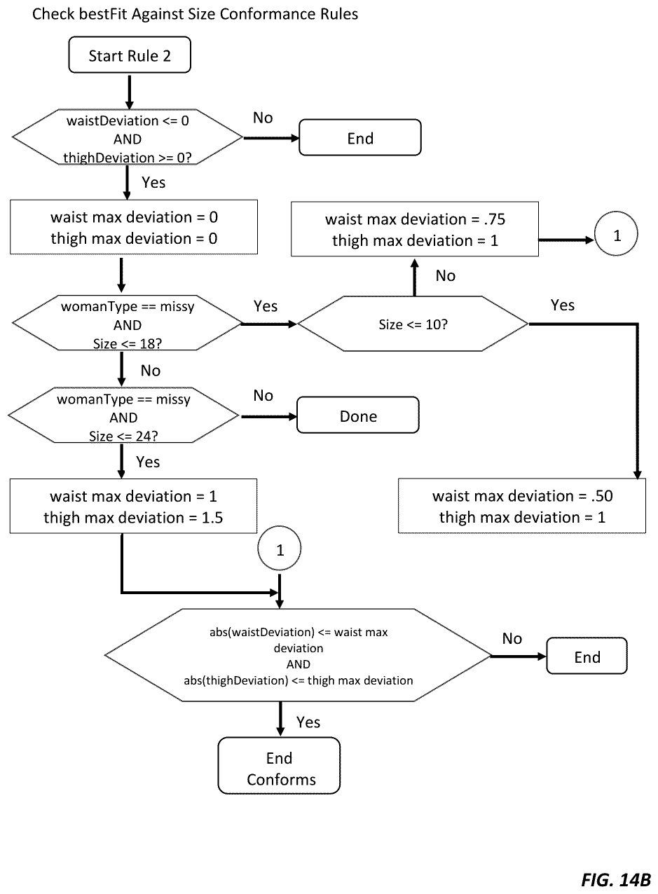

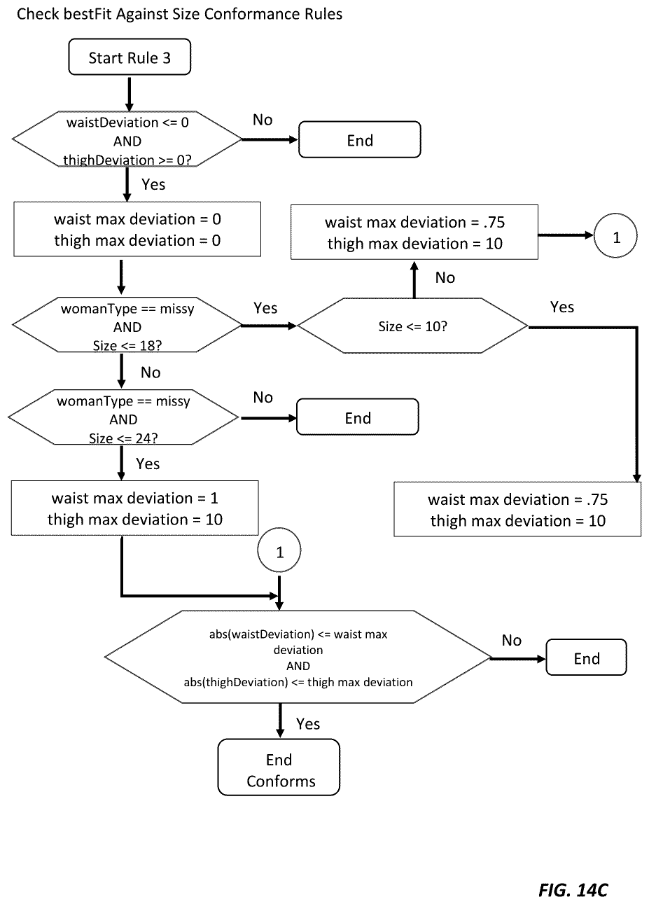

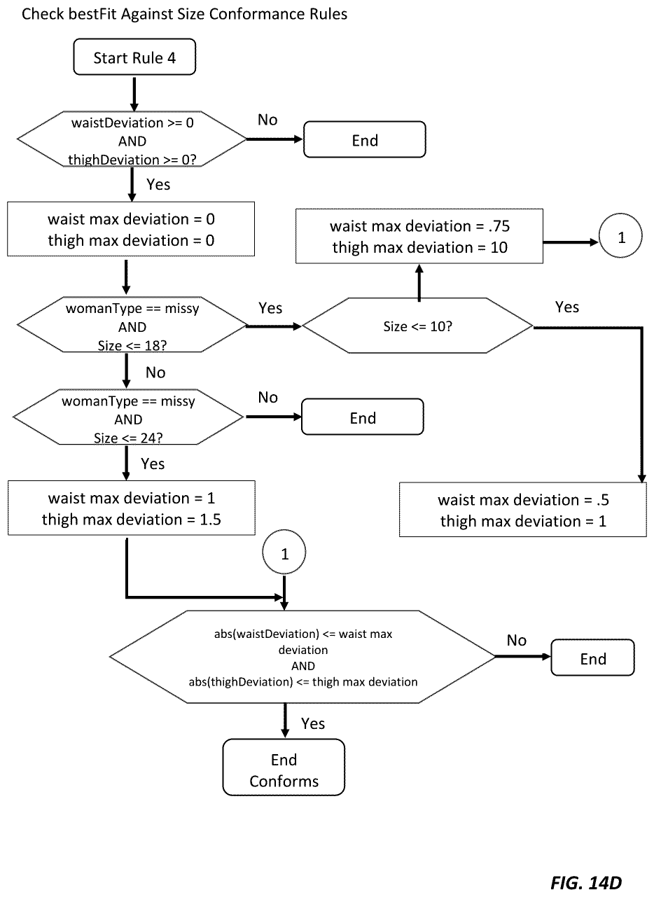

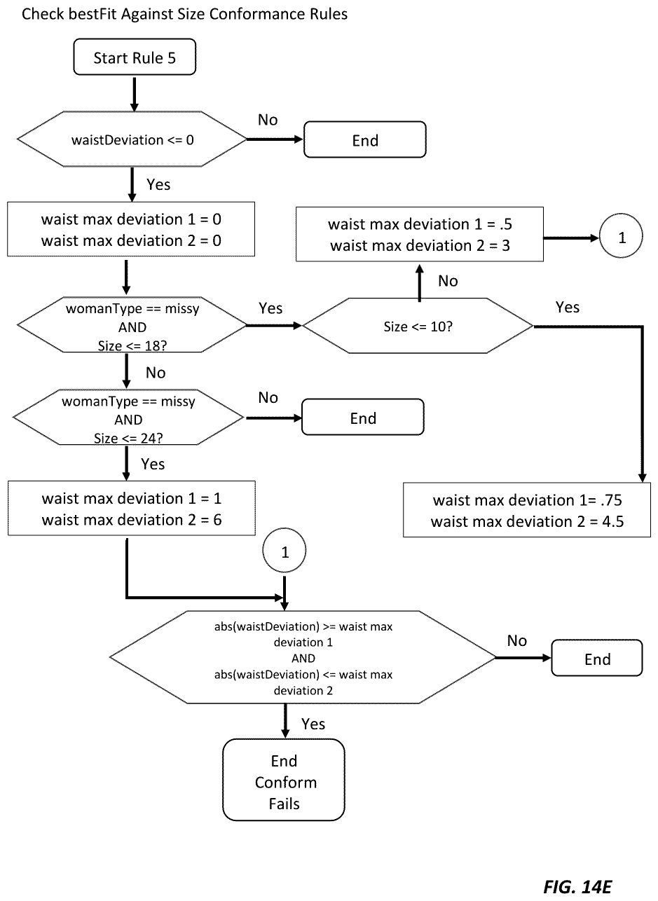

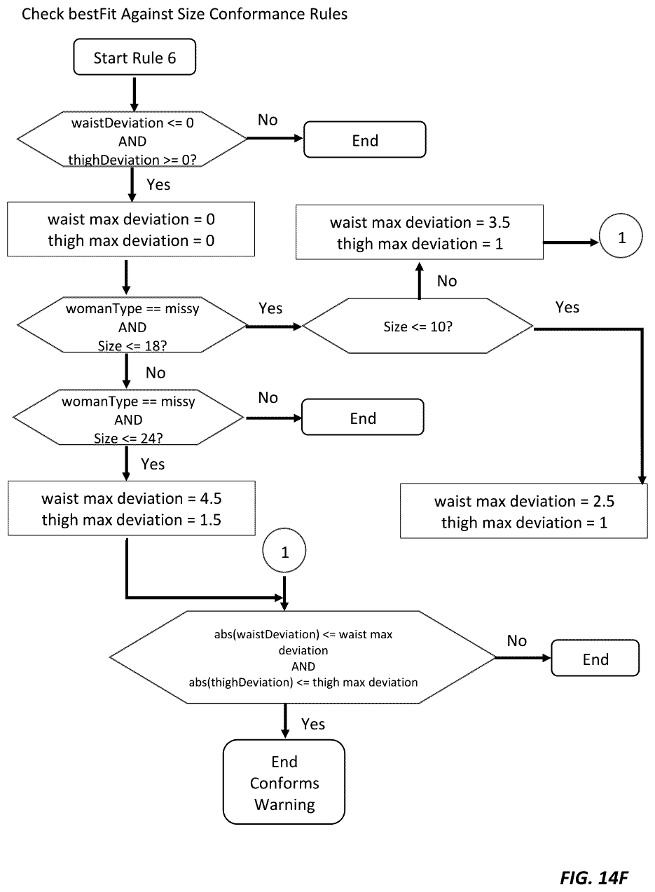

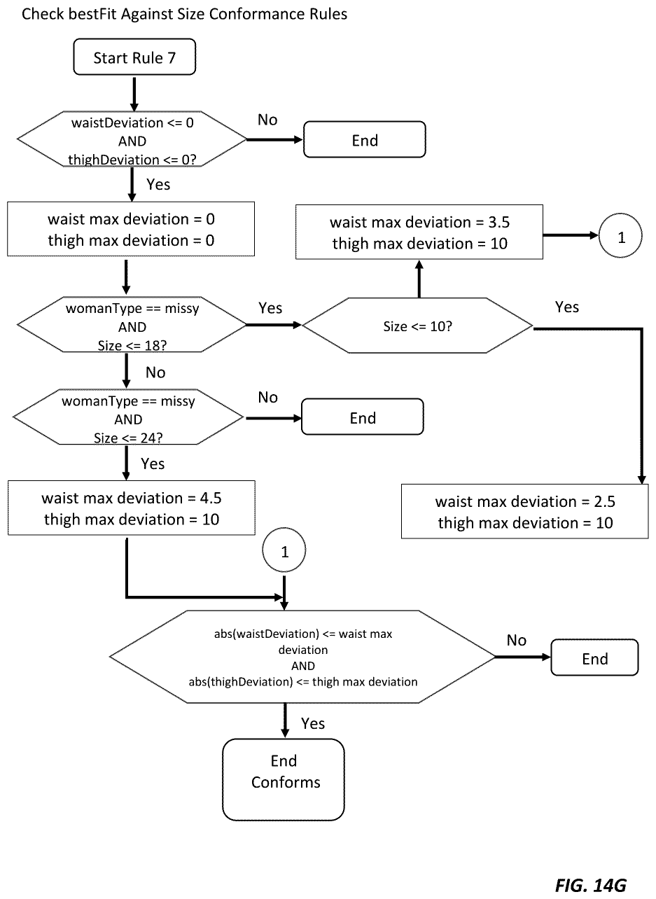

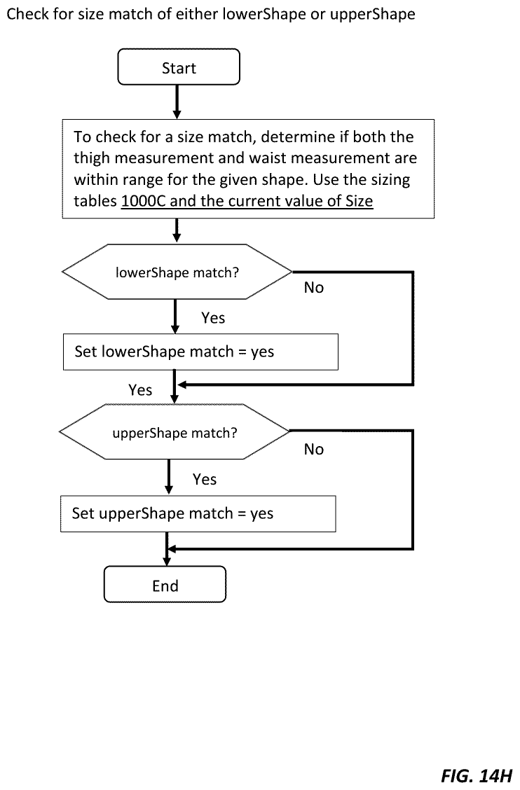

This better fit determination starts with the function exemplified in FIG. 14H which uses the lowerShape and upperShape along with the currentSize for each of those shapes to simply decide which of the shapes are basically a match, where a “match” is defined as the case where the currentSize for that shape is within the specified size range. The flow scans the sizing table 1002 for the waist and thigh this time and determines which of those measurements (if any) are within range for the current size. This test simply sets a variable for lowerShape and upperShape to match or not match.

Referring back to the flow in FIG. 11B, there is first a test to see if both shapes match. If they both match, a finalShape variable is set to the lowerShape unless the upperShape is the same as the defaultShape, in which case the finalShape is set to the upperShape. In either case the finalSize is set to the currentSize for that shape.

If both shapes do not match, another test is performed to determine if one of them matches. If so, that shape is set as the finalShape. If neither matches, then the function find best fit between two shapes (1106) is executed to determine if one of the shapes is nonetheless acceptable even though not a perfect match (discussed further below). If one of them is acceptable, that is set as the finalShape and its size as the finalSize. If neither are acceptable, the illustrative algorithm implements a set of rules (conformity rules) to test alternative sizes (typically incrementing to larger sizes) in an attempt to find an acceptable size. In the flow chart depicted in FIG. 11B, this is referred to as the function call 1106, perform incCheck. It is noted that this process is repeated and, for this pants example, is repeated up to three times. If after these attempts, there still hasn't been an acceptable size found, the cross-check algorithm fails and ends up using the perception fit as the final fit.

As shown in FIG. 11C, once the process described above is complete and a final fit has been determined, the final fit label is generated. Note that the process of working through the conformity rules can also create a final fit warning message to be displayed to the user in addition to the final fit label itself. Thus, this inventive process supports determining a best fit but, for some cases, includes a disclaimer (warning) that might be helpful for the user to better interpret the fit (i.e., by indicating that the garment may fit tighter).

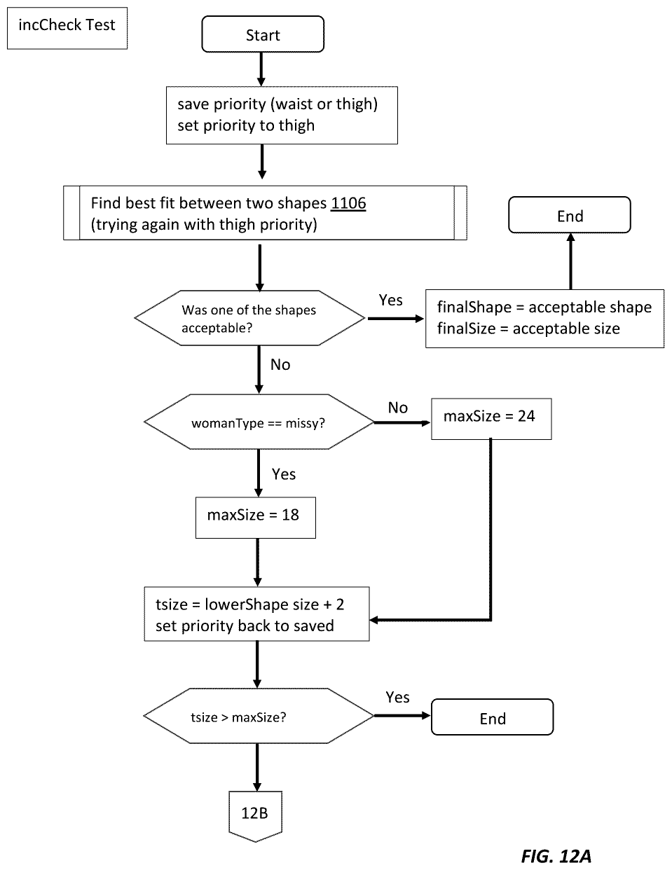

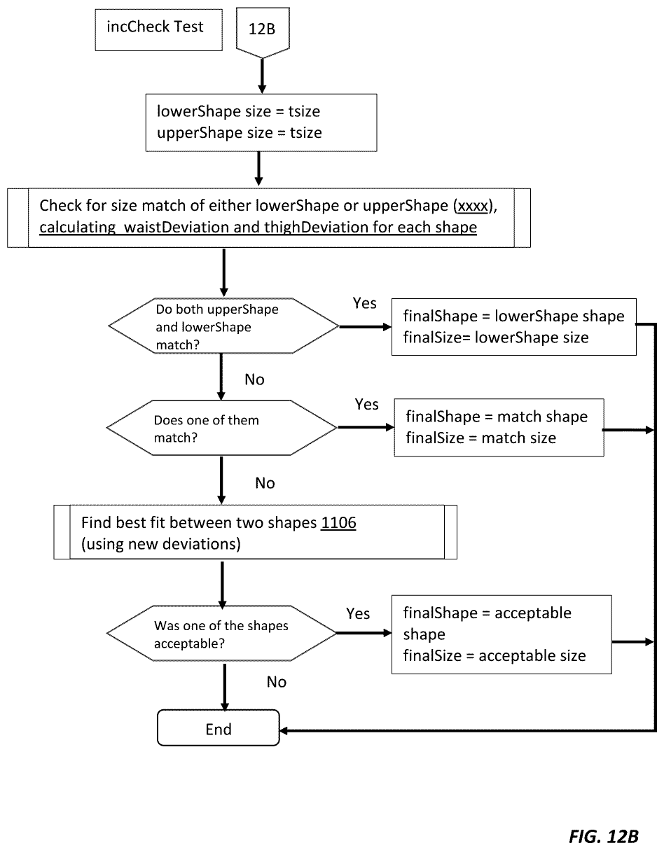

The incCheck method call 1106 is processed by the function depicted in FIGS. 12A and 12B. As indicated above, this function is used when the algorithm has determined that neither of the sizes for the shapes under consideration (where such size was determined using the hip measurement) fit very well with regard to either the waist or thigh (or both). As an example, consider a size within a shape where the hip fits well but the waist as measured is too large for that shape/size. What is needed at this point (for that example) is to look at the next larger size to see if then the waist and thigh would fit where that determination of fit conforms to a set of rules that depict some level of leniency (conformity rules). Each time the incCheck method is performed, it either determines a finalShape and finalSize based on what is acceptable according to the rules, or increments to the next size and rechecks to see if it now has a match. As indicated above, this process is repeated at most three times for this embodiment.

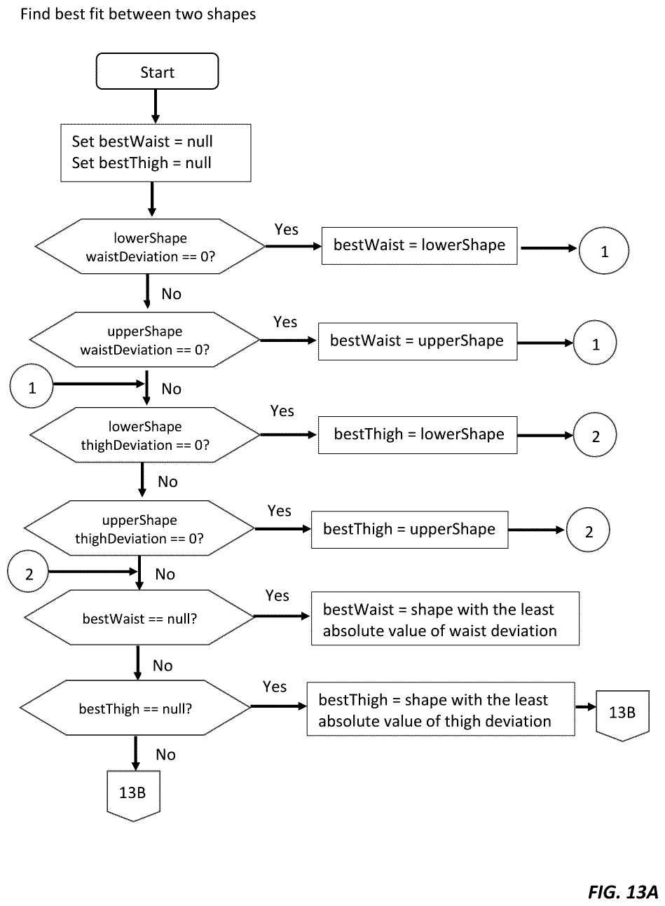

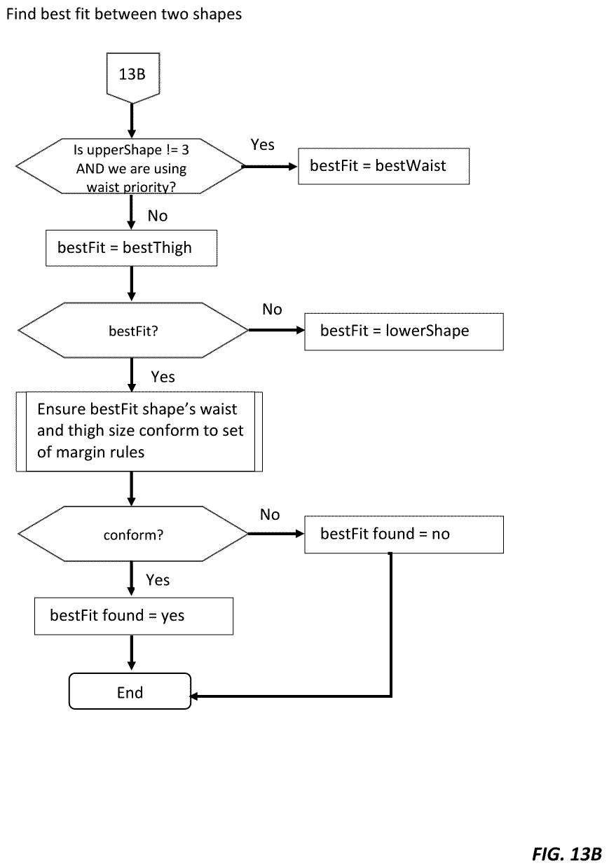

In two places in the flowchart (predict final fit method and the incCheck method), a find best fit between two shapes function 1106 is called and is depicted in FIGS. 13A and 13B. This function basically analyzes the waist and thigh measurement deviations (again, continuing with the pants garment type example) to determine which shapes has the bestThigh and bestWaist and then, according to whether the testing is done with a waist or thigh priority, a shape that is best is selected. Then, importantly, the algorithm checks this bestFit's shape waist and thigh sizes against a set of conformity rules such that if the rules permit, the 1106 function can declare a best fit has been found (said declaration is then used in the incCheck and/or predict final fit methods).

An example set of conformity rules are depicted in FIGS. 14A, 14B, 14C, 14D, 14E, 14F, and 14G. The set of rules are constructed such that they are executed in the order specified. Each rule executed can end with a declaration of “conforms” or simply ends with a “no conform” declaration. The first rule that ends with “conforms” causes the rule sequence execution to stop with an overall declaration of “conforms”. Using Rule 1 depicted in FIG. 14A as a preferred example, there is shown a rule that basically will declare that there is conformity if and only if the absolute value of the waist deviation is less than or equal to a calculated max waist deviation and the absolute value of the thigh deviation is less than or equal to a calculated max thigh deviation. The calculations for the max waist and thigh deviations for this rule are based on this magnitude of the size and missy vs women classification discussed earlier. Rule 1 is focused on a case where the waistDeviation indicates that the waist is too small, while the thigh is too big (otherwise the rule will immediately end with no “conforms” declaration). Rules 2 and 3 (FIGS. 14B and 14C) are constructed similarly with different degrees of leniency.

Rule 4 (FIG. 14D) on the other hand is focused on a case where the deviation calculations indicate that both the waist and thigh are too large, calculating and checking against a leniency factor for that situation.

Rule 5 (FIG. 14E) handles all cases where the waist is too small and that isn't covered in the previous 4 rules. The objective of this example rule is to determine if the waist falls within a range to declare that we can't conform, declaring no additional rules should be executed.

Rule 6 (FIG. 14F) is an example of a rule constructed to declare conformity but with a warning.

Rule 7 (FIG. 14G) handles a set of cases where the waist and thigh are both too small and supports conformity declaration as long as those deviations are within a certain leniency.

The details associated with the figures and included flowcharts are described as a preferred embodiment but is not considered. Those of ordinary skill in the art will recognize that many variations of garment types, garment shapes, and size ranges within shapes can be accommodated and still fall within the scope of the disclosure. The details specified in these examples are not intended to be limiting.

We claim:

1. A method for providing a garment fit to a client of a garment fit system which provides access to the client over an electronic network, the method comprising:
providing an electronic user interface to the client, the electronic user interface including access to a fit perception query and body measurement capture workflow;
receiving, from the client, a garment fit query including a selected garment type, perception of garment fit for the selected garment type, and a set of client body measurements;
calculating a predicted perception fit for the client; and
calculating a predicted final fit for the client based on the predicted perception fit and the client body measurements of the client.

2. The method of claim 1, wherein the body measurement capture workflow includes capturing client body images using a camera and analyzing said images to determine body measurements of the customer client.

3. The method of claim 2, wherein the body measurements are specific points of measurement based on the selected garment type.

4. The method of claim 1, wherein the step of calculating the predicted perception fit includes providing a predicted fit label indicative of garment size and shape, the predicted fit label being determined based on coded responses to the fit perception query which are stored in one or more data tables.

5. The method of claim 1, wherein the step of calculating the predicted final fit for the client includes providing a final fit label indicative of garment size and shape, the final fit label being determined based on coded responses to the fit perception query and the client body measurements which are stored in one or more data tables.

6. A system for providing a garment fit to a client of a garment fit system which provides access to the client over an electronic network, the system comprising:
a non-transitory computer-readable medium with instructions encoded thereon and one of more processors configured to, when executing the instructions, perform operations of:
providing, via an electronic user interface, a fit perception quiz and body measurement capture workflow for a garment selected by the client;
coding garment fit query responses received from the client, the coded query responses being associated with a garment type, client perception of garment fit, and a set of client body measurements;
determining a predicted perception fit of the selected garment for the client based on data associated with the coded garment type and client perception of garment fit; and
determining a predicted final fit based on the predicted perception fit and the body measurements.

7. A method for providing a garment fit to a consumer by a garment fit system providing access to the consumer over an electronic network, the method comprising:
receiving, at a fit analysis subsystem of the garment fit system, perception metadata representative of a perceived fit of a garment selected by the consumer, said perception metadata including a metric that characterizes perceived size and shape associated with a fitting of the selected garment on the consumer, said perception metadata being inputted into the fit analysis subsystem by the consumer via a user interface;
receiving, at a measurement analysis subsystem of the garment fit system, measurement metadata including measured dimensions of the consumer located at predetermined points of measurement associated with the selected garment;
determining, by the fit analysis subsystem, a predicted perception fit label for the selected garment, said predicted perception fit label including at least size and shape values corresponding to the perception metadata from the consumer;
comparing, via the fit analysis subsystem, the predicted perception fit label to the received measured dimensions of the consumer; and
adjusting the predicted perception fit label based on the measured dimensions of the consumer to provide a final fit label that includes at least final size and shape values of the selected garment.

8. The method of claim 6, further comprising:
displaying, on a user interface connected to the electronic network, at least one image of the selected garment associated with the final fit label; and
presenting purchasing information to enable the consumer to buy the selected garment over the electronic network.

9. The method of claim 7, wherein the purchasing information includes values associated with at least one of style variations, quantity and price.

10. The method of claim 8, wherein the style variations include at least one of a choice of patterns, colors, fasteners and fabrics.
